(19) United States
(12) Patent Application Publication
(10) Pub. No.: US 2013/0280312 A1
(43) Pub. Date: Oct. 24, 2013

(54) Skin Sanitizer Compositions Comprising Alcohol Based Emulsion

(71) Applicant: Sarah De Szalay, Montvale, NJ (US)

(72) Inventor: Sarah De Szalay, Montvale, NJ (US)

(73) Assignee: RECKITT & COLMAN (OVERSEAS) LIMITED, Berkshire (GB)

(21) Appl. No.: 13/997,279

(22) PCT Filed: Nov. 7, 2011
(86) PCT No.: PCT/GB2011/052152

§ 371 Date: Jul. 2, 2013

(30) Foreign Application Priority Data
Dec. 24, 2010 (GB) 1021937.6

(51) Int. Cl. A01N 31/02

(52) U.S. Cl. CPC A01N 31/02
USPC 424/408; 514/724

(57) ABSTRACT

Topical germicidal compositions for application to the epidermis, e.g., hands, arms, legs, face, scalp as well as other body areas, which topical germicidal compositions provide a skin sanitization benefit due to the presence of a large amount of alcohol, yet which impart skin treatment benefits to treated dermal surfaces. The topical germicidal compositions necessarily comprise at least 50% wt. of a C1-C4 monohydric alcohol, preferably ethanol, water and lipid based nanoparticles.

The present invention relates to sanitizer compositions which may be topically applied, which provide skin sanitization benefits.

Topical compositions, per se, are well-known in the cosmetic, dermatological as well as in the pharmaceutical fields. Most topical compositions are intended to provide at least one but generally provide multiple or more specific benefits after being applied to the human skin. For example, personal care compositions which are primarily intended to be soaps for general cleaning of the human skin such as hand soaps or body wash soaps are well known in the fields of cosmetics and personal care products. While providing a primary cleaning benefit, such personal care compositions frequently also provide ancillary benefits such as moisturizing and nourishing the skin. Such personal care compositions which provide a good general cleaning benefit are usually based on one or more anionic soaps or anionic surfactants which are recognized to provide good cleaning and good foaming. However, such compositions typically provide only limited germicidal benefits.

Also known to the art are topical compositions which are primarily directed to provide a germicidal benefit to the epidermis or other body part when applied thereto. Such typically take the form of viscous gels and are often largely comprised of an alcohol, usually ethanol, with further constituents, e.g., thickeners. While often technically effective to provide a germicidal benefit, such compositions are also not without shortcomings, including in some cases, an unpleasant skin feel and in other cases, an undesired drying effect to the skin.

Thus, there remains a continuing need in the art for further improved topical compositions, particularly topical compositions which provide a skin sanitization benefit due to the presence of a large amount of alcohol, yet which impart skin treatment benefits to treated dermal surfaces. The remains a concurrent need in the art for improved methods for the production of such improved topical compositions as well as methods for their use. It is to these and further objects that the present invention is directed.

In a first aspect of the invention there are provided topical germicidal compositions for application to the epidermis, e.g., hands, arms, legs, face, scat as well as other body areas, which topical germicidal compositions provide a skin sanitization benefit due to the presence of a large amount of alcohol, yet which impart skin treatment benefits to treated dermal surfaces.

According to a second aspect of the invention is provided a method for the manufacture or production of improved topical germicidal composition as set forth herein.

In a third aspect, the present invention provides a topical germicidal composition according to the any of the prior aspects of the invention, characterized in that the said composition is effective against undesired microorganisms.

According to a fourth aspect, there is provided a the topical germicidal compositions as described herein which may be provided in a variety of vendible product forms, e.g., viscous flowable forms, such as gels, creams or pastes as well as readily flowable forms adapted to be poured from a bottle or flask, or more flowable forms suitable to be dispensed from such a bottle, flask or other reservoir via a nozzle or a pump, e.g., a manually operable pump or a manually operable trigger spray.

These and further aspects of the invention are provided as described within this specification.

The primary constituent of the topical germicidal compositions is an alcohol constituent, comprising one or more C₁-C₄ monohydric alcohols, e.g., one or more alcohols selected from methanol, ethanol, n-propanol, isopropanol, and all isomers of butanol. Isopropanol, although often used on the skin, is less desirable for use in the present invention because of its severe defatting tendency. Its defatting tendency may, however, be compensated for by adding sufficient emollient ingredient if desired to offset this tendency. Preferred alcohols according to the present invention are however ethanol and n-propanol, and especially preferably ethanol to the exclusion of further C₁-C₄ monohydric alcohols. In the present invention, when more than one alcohol is used, the alcohols are mixed at a concentration that is peak for their activity. Ethanol is included for its reduced defatting activity and for activity against viruses, especially the lipophilic group; while the inclusion of n-propanol enhances the contribution of the alcohol constituent to the overall germicidal efficacy of the topical germicidal compositions of which they form a part. In certain preferred embodiments the alcohol constituent comprises at least 50% wt., or (in order of increasing preference) at least 55% wt., 60% wt., 65% wt., 70% wt., 75% wt., 80% wt., 85% wt., 90% wt., 95% wt., and especially preferably comprises at least 100% wt. ethanol. The alcohol constituent itself comprises at least 50% wt., preferably comprises at least 55% wt., still more preferably comprises at least 60% wt. of the topical germicidal compositions of which it forms a part. Concurrently the alcohol constituent desirably comprises not more than 85% wt., preferably not more than 80% wt., still more preferably not more than 75% wt., and especially preferably comprises not more than 70% wt. of the topical germicidal compositions. Particularly preferred amounts of the alcohol constituent and the identity thereof are disclosed in one or more of the following examples.

As a further essential constituent the inventive compositions comprise are lipid based nanoparticles which are compatible with the highly alcoholic content of the topical germicidal compositions of the present invention. The lipid based nanoparticles of the invention comprises at least one lipid component, and may comprise one or more further components, which may provide a skin treatment benefit, skin conditioning benefit, or other technical or aesthetic benefit to the dermal surface being treated. The lipid component may be one or more compounds selected from the group comprising amphiphiles, lipids and/or detergents. Preferably, it comprises at least one compound selected from phospholipides, glycolipids, cholesterols, sphingolipides, polyethylene glycol lipid derivatives, cationic lipides, triglycerides and waxes. Mixtures of several different lipids may also be used in the lipid based nanoparticles. When using a mixture of several lipids as lipid component, said mixture may be employed as a solid mixture or as a mixture of single lipid crystals The lipid-based nanoparticles may exist as solid substance of dispersed in an aqueous component. Preferably, they are liposomes, solid liquid nanoparticles (“SLN”) or emulsion droplets (“SME”). According to certain particularly preferred embodiments, the lipid based nanoparticles of the invention are solid lipid nanoparticles” (SLN), also designated as “solid lipid nanoparticles”, are nanoparticles in the size range of from about 10 to about 1000 nm (if a nanoparticle must not have a size of 1000 nm by definition, “up to 1000 nm” means “up to 1000 nm”, that is, less than 1000 nm in this context), preferably of from about 50 to about 600 nm, and especially preferably from about 100 to about 500 nm. Physiologically compatible lipids, corresponding triglycerides or also waxes may also be used as solid lipids. However, also nonphysiological lipids may be used. Advantageously, one or more further constituents are incorporated in the SLN either by dissolution or dispersion. SLN may be formulated both as aqueous dispersions and as dry products (lyophilization or spray-drying). Thus the SLN advantageously functions as a carrier for one or more further constituents in the predominantly alcoholic topical germicidal compositions of the present invention, or alternately function as a co-carrier or compatibilizing constituent for one or more further constituents in the predominantly alcoholic topical germicidal compositions of the present invention. Non-limiting examples of such one or more further constituents include one or more further constituents which provide a skin treatment benefit thereto, particularly one or more further constituents which provide a nutritional, occlusive, emollient, antibacterial, or other technical, aesthetic or cosmetic benefit to topical surfaces upon which the topical germicidal compositions are applied. The present inventor has surprisingly found that the use of lipid based nanoparticles, and especially the use of SLN in the topical germicidal compositions of the present invention permits for the production of stable topical germicidal compositions which may now include one or more further constituents which were previously considered unsuitable for use in predominantly alcoholic systems. These lipid based nanoparticles permit for the formation of an emulsion in the predominantly alcoholic topical germicidal compositions of the present invention, which exhibit good stability with the use of a minimum amount of aminoic, cationic, nonionic, or amphoteric surfactants in the compositions. These lipid based nanoparticles permit for the incorporation of lipophilic constituents into the predominantly alcoholic topical germicidal compositions of the present invention.

Examples of useful and preferred lipid based nanoparticles which are presently commercially available and which may be used include NanoSolve™, Ultrasphere s®, Ceraspheres® (all, ex. Lipod GmbH, Ludwigshafen, Germany) as well as Supravail™ (Phares Drug Delivery AG, Switzerland). Further examples of liposomes, SLN and SME are disclosed in US 2008/0193511, the contents of which are herein incorporated by reference, which discloses processes for the manufacture of SLN, but which further generally discloses lipid based nanoparticles. Specific examples of lipid based nanoparticles include: NanoSolve™ 4101 which is described to be a SLN containing 4% Ceramide II, 4% cholesterol, and phospholipids; NanoSolve™ 4022 which is described to be a SLN containing 10% Coenzyme Q10; NanoSolve™ 4300 which is described to be a SLN containing phytosterol; NanoSolve™ 5428 which is described to be a SLN containing lutein; NanoSolve™ 8004 which is described to be a SLN containing 25% Vitamin E acetate; NanoSolve™ 8034 which is described to be a SLN containing 5% Vitamin A palmitate; NanoSolve™ 4101 which is described to be a SLN containing curcumin, as well as Ultraspheres® 8045 which is described to be a SLN with 5% retinyl palmitate.

The lipid based nanoparticles of the invention may be provided in virtually any amount which is found to be effective, but advantageously the lipid based nanoparticles are present in amounts of at least about 0.01% wt., to about 10% wt., based on the total weight of the germicidal topical compositions of which they form a part. Preferably they comprise at least about 0.01% wt, and in order of increasing preference, comprise at least about 0.05%, 0.1%, 0.2%, 0.3%, 0.4%, 0.5%, 0.6%, 0.7%, 0.8%, 0.9% and especially at least about 1% wt. of the germicidal topical compositions of which they form a part. Preferably they comprise up to about 10% wt., and in order of increasing preference, up to about 9%, 8%, 7%, 6% and up to about 5% wt. based on the total weight of the germicidal topical compositions of which they form a part. Examples of particularly preferred weight percentages in germicidal topical compositions are disclosed with reference to one or more of the examples.

As noted these lipid based nanoparticles permit for the incorporation of lipophilic constituents into the predominantly alcoholic topical germicidal compositions.

The topical germicidal compositions of the invention include a minor amount of water. The water may be tap water, but is preferably distilled water but more preferably is deionized water. The water is present in the topical germicidal compositions of the invention in an amount less than 45% wt. of the composition of which it forms a part. Advantageously water comprises not more than 40% wt., and in order of increasing preference comprises not more than 35%, 34%, 33%, 32%, 31%, 30%, 29%, 28%, 27%, 26%, 25%, 24%, 23%, 22%, 21%, 20% of the compositions. Concurrently, advantageously the water comprises at least 1%, and in order of increasing preference comprises at least 5%, 10%, 11%, 12%, 13%, 14%, 15%, 16%, 17%, 18%, 19%, 20%, 21%, 22%, 23%, 24% and 25% of the topical germicidal compositions of which water forms a part.

In addition to the essential constituents disclosed in this specification, the topical germicidal compositions of the invention may include one or more further optional constituents which may be used to improve one or more aesthetic and/or technical characteristics of the composition of which they form a part. Typically they are included in only small amounts, and usually the cumulative amount of any such optional constituents does not exceed 35% wt. of the topical germicidal compositions of which they form a part. In certain preferred embodiments of the invention, one or more of the following recited optional constituents may be considered as essential constituents according to a particular preferred embodiment. Such optional constituents include, inter alia: additives and adjuvants which are conventional in the cosmetic, pharmaceutical or dermatological field, e.g., emulsifiers, particulates, fillers, emollients, skin conditioning agents, humectants, preservatives, antioxidants, solvents especially organic solvents, pH adjusting agents, pH buffers, chelating agents, fragrances, or other materials which provide an aromatherapy benefit, vitamins, fillers, preservatives, dyestuffs or colorants, and light stabilizers including UV absorbers.

The topical germicidal compositions may comprise one or more humectants, including polyhydric alcohols including polyalkylene glycols as well as alkylene polyols and their derivatives, inter alia, including propylene glycol, dipropylene glycol, polypropylene glycol, polyethylene glycol and derivatives thereof, sorbitol, hydroxypropyl sorbitol, erythritol, threitol, pentaerythritol, xylitol, glucitol, mannitol, hexylene glycol, butylene glycol (e.g., 1,3-butylene glycol), hexane triol (e.g., 1,2,6-hexanetriol), glycerine, ethoxylated glycerine and propoxylated glycerine. Further useful humectants include sodium 2-pyrrolidone-5-carboxylate, guanidine; glycolic acid and glycolate salts (e.g. ammonium and quaternary alkyl ammonium); lactic acid and lactate salts (e.g. ammonium and quaternary alkyl ammonium); aloe vera in any of its variety of forms (e.g., aloe vera gel); hyaluronic acid and derivatives thereof (e.g., salt derivatives such as sodium hyaluronate); lactamide monoethanolamine; acetamide monoethanolamine; urea; and, panthenol. Still further humectants include polyols e.g., linear and branched chain alkyl polyhydroxyl compounds such as, propylene glycol, polyethylene glycol, glycerine and sorbitol. Exemplary hydrocarbons which may also serve as humectants are those having hydrocarbon chains anywhere from 12 to 30 carbon atoms, particularly, mineral oil, petroleum jelly, squalene and isoparaffins.

The humectants may be used singly or two or more humectants may be included in topical germicidal compositions of the invention. In preferred embodiments, one or more humectants may be included in effective amounts, advantageously from 0.01-10% wt., preferably from 0.1-5% wt., and especially preferably from 0.1-2% wt. based on the total weight of the composition of which it forms a part. In particularly preferred embodiments, the humectant is selected from polyhydroxy alcohols, such as glycerine, and/or alkoxlated polyhydroxy alcohols, such as ethoxylated glycerine and propoxylated glycerine as well as 1,3-propanediol. Polyhydroxy alcohols, especially glycerine are especially preferred. Particularly preferred amounts, and humectants, are disclosed with reference to one or more of the Examples.

The compositions of the invention may optionally include a thickener constituent. Such may for example, be based on cellulose or one or more cellulose derivatives. Such thickener constituents are per se, known to the art and exemplary useful cellulose derivatives useful as a thickener constituent include methyl cellulose ethyl cellulose, hydroxymethyl cellulose hydroxy ethyl cellulose, hydroxy propyl cellulose, carboxy methyl cellulose, carboxy methyl hydroxyethyl cellulose, hydroxypropyl cellulose, hydroxy propyl methyl cellulose, ethylhydroxymethyl cellulose and ethyl hydroxy ethyl cellulose. Of the foregoing hydroxypropyl methyl cellulose is particularly preferred for use in preferred compositions of the invention.

Further useful as a thickener constituent is one or more thickener constituents based on crosslinked polycarboxylate and/or polyacrylate polymer thickeners; including those typically exhibit a molecular weight from about 500,000 to about 4,000,000, and generally have degrees of crosslinking of from about 0.25% to about 15%. Such crosslinked polycarboxylate and/or polyacrylate polymers may include in their structure other monomers besides acrylic acid such as ethylene and propylene which act as diluents, and maleic anhydride which acts as a source of additional carboxylic groups. Such thickener constituents based on crosslinked polycarboxylate and/or polyacrylate polymer thickeners are widely commercially available and include, e.g., polycarboxylate polymers and/or polyacrylate polymers sold under trade names Carbopol®, Acrysol® ICS-1 and Sokalan®.

Still further examples of thickener constituents are one or more clay thickeners. Exemplary clay thickeners comprise, for example, colloid-forming clays, for example, such as smectite and attapulgite types of clay thickeners. The clay materials can be described as expandable layered clays, i.e., aluminosilicates and magnesium silicates. The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites).

A further thickener constituent is one or more thickeners based on naturally occurring polysaccharide polymers such as xanthan gum, guar gum, locust bean gum, tragacanth gum, or derivatives thereof.

Any of the thickeners, when present, may be present in any amount which is found effective in achieving a desired degree of thickening. When present, advantageously such one or more thickener constituents may be present in amounts of from about 0.001% wt. to about 10% wt., preferably from about 0.01% wt. to about 5% wt., based on the total weight of the topical germicidal composition of which it forms a part.

In certain embodiments of the invention one or more of the recited thickeners are expressly included within the topical germicidal compositions and form an essential constituent thereof.

In certain embodiments of the invention one or more of the recited thickeners are expressly excluded from the topical germicidal compositions.

The topical compositions of the invention may optionally comprise one or more emollients which provide softness to the topical germicidal compositions. Non-limiting examples of useful emollients include those, for example, compounds based on Guerbet alcohols based on fatty alcohols containing 6 to 18 and preferably 8 to 10 carbon atoms and other additional esters, such as myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. Also suitable are esters of C₁₈₋₃₈ alkyl-hydroxycarboxylic acids with linear or branched C₆₋₂₂ fatty alcohols, more especially dioctyl malate, esters of linear and/or branched fatty acids with polyhydric alcohols (for example propylene glycol, dimer diol or trimer triol), triglycerides based on C₆₋₁₀ fatty acids, liquid mono-, di- and triglyceride mixtures based on C₆₋₁₈ fatty acids, esters of C₆₋₂₂ fatty alcohols and/or Guerbet alcohols with aromatic carboxylic acids, more particularly benzoic acid, esters of C₂₋₁₂ dicarboxylic acids with polyols containing 2 to 10 carbon atoms and 2 to 6 hydroxyl groups, vegetable oils, branched primary alcohols, substituted cyclohexanes, linear and branched C₆₋₂₂ fatty alcohol carbonates such as, for example, dicaprylyl carbonate (commercially available as Cetiol® CC), Guerbet carbonates based on fatty alcohols containing 6 to 18 and preferably 8 to 10 carbon atoms, esters of benzoic acid with linear and/or branched C₆₋₂₂ alcohols (for example, a product commercially available as Finsolv® TN), linear or branched, symmetrical or nonsymmetrical dialkyl ethers containing 6 to 22 carbon atoms per alkyl group such as, for example, dicaprylyl ether (commercially available as Cetiol® OE), ring opening products of epoxidized fatty acid esters with polyols and hydrocarbons or mixtures thereof (commercially available as Cetiol® DD), propylheptyl caprylate (commercially available as Cetiol® SenSoft) as well as the compounds disclosed in published US Patent application 2009/0182046 the contents of which are herein incorporated by reference.

The germicidal topical composition may include a Polyquaternium compound or material, which are typically cationic polymers. Such materials, are, per se, well known to the art of topical compositions. Various grades of such cationic polymers may be used, inter alia: Polyquaternium 1; Polyquaternium 2; copolymers of hydroxyethylcellulose and diallyldimethyl ammonium chloride commercially available as Polyquaternium 4; homopolymers of diallyldimethylammonium chloride commercially available as Polyquaternium 5; dimethyldiallyammonium chloride homopolymer commercially available as Polyquaternium 6; copolymers of diallyldimethylammonium chloride with acrylamide commercially available as Polyquaternium 7; the polymeric quaternary ammonium salt of methyl and steardyl dimethylaminoethyl methacrylate quaternized with dimethyl sulfate commercially available as Polyquaternium 8; the polymeric quaternary ammonium salt of polydimethylaminoethyl methacrylate quaternized with methyl bromide commercially available as Polyquaternium 9; a polymeric quaternary ammonium salt formed from the reaction of hydroxyethyl cellulose with a trimethylammonium substituted epoxide commerically available as Polyquaternium 10; a polymeric quaternary ammonium polymer formed by the reaction of vinyl pyrrolidine and dimethyl aminoethylmethacrylate commercially available as Polyquaternium 11; a polymeric quaternary ammonium salt prepared by the reaction of ethyl methacrylate/abietyl methacrylate/diethylaminoethyl methacrylate copolymer with dimethyl sulfate commercially available as Polyquaternium 12; a polymeric ammonium salt prepared by the reaction of ethyl methacrylate/oleyl methacrylate/diethylaminoethyl methacrylate copolymer with dimethyl sulfate commercially available as Polyquaterinum 12; a polymeric quaternary ammonium salt prepared by the reaction of ethyl methacrylate/oleyl methacryalte/diethylaminoethyl methacrylate copolymer with dimethyl sulfate commercially available as Polyquaternium 13; Polyquaternium 14; the copolymer of methacrylamide and betamethacrylyloxyethyl trimethyl ammonium chloride commercially available as Polyquaternium 15; the polymeric quaternary ammonium salt formed from methylvinylimidazolium chloride and vinylpyrrolidone commercially available as Polyquaternium 16; polymeric quaternary salts prepared by the reaction of adipic acid and dimethylaminopropylamine reached with dichloroethyl ether commercially available as Polyquaternium 17; a polymeric quaternary salt prepared by the reaction of azelaic acid and dimethylaminopropylamine reacted with dichloroethyl ether commercially available as Polyquaternium 18; a polymeric quaternary ammonium salt prepared by the reaction of polyvinyl alcohol with 2,3-epoxy-propylamine commercially available as Polyquaternium 19; a polymeric quaternary ammonium salt prepared by the reaction of polyvinyl octadecyl ether with 2,3-epoxypropylamine commercially available as Polyquaternium 20; copolymers of acrylic acid and dimethyldiallylammonium chloride commercially available as Polyquaternium 22; polymeric quaternary ammonium salts of hydroxyethyl cellulose reacted with lauryl dimethyl ammonium-substituted epoxide commercially available as Polyquaternium 24; a block copolymer formed by the reaction of Polyquaternium 2 and Polyquaternium 17 commercially available as Polyquaternium 27; a polymeric quaternary ammonium salt consisting of vinylpyrrolidone and dimethylaminopropyl methacrylamide monomers commercially available as Polyquaternium 28; chitosans reacted with propylene oxide and quaternized with epichlorohydrin commercially available as Polyquaternium 29; Polyquaternium 30; a polymeric quaternary ammonium salt prepared by the reaction of DMAPA acrylates/acrylic acid/acrylonitrogens copolymer with diethyl sulfate commercially available as Polyquaternium 31; Polyquaternium 32; Polyquaternium 33; Polyquaternium 34; Polyquaternium 35; Polyquaternium 36; Polyquaternium 37; polymeric quaternary ammonium salts of the terpolymer of acrylic acid/diallyldimethylammonium chloride/acrylamide commercially available as Polyquaternium 39; Polyquaternium 42; a copolymer of acrylamide, acrylamidopropyltrimonium chloride, 2-amidopropylacrylamide sulfonate and DMAPA polymers commercially available as Polyquaternium 43; a polymeric quaternary ammonium salt consisting of vinylpyrrolidone and quaternized imidazoline monomers commercially available as Polyquaternium 44; Polyquaternium 45; a polymeric quaternary ammonium salt prepared by the reaction of vinylcaprolactam and vinylpyrrolidone with methylvinylimidazolium commercially available as Polyquaternium 46; a polymer quaternary ammonium chloride formed by the polymerization of acrylic acid with methacrylamidopropyl trimethylammonium chloride and methylacrylate commercially available as Polyquaternium 47; a copolymer of methacryloyl ethyl betaine, 2-hydroxyethyl methacrylate and metacyloyl ethyl trimethyl ammonium chloride commercially available as Polyquaternium 48; a copolymer of methacryloyl ethyl betaine, PEG-9 methacrylate and methacryloyl ethyl trimethyl ammonium chloride commercially available as Polyquaternium 49; Polyquaternium 50; Polyquaternium 51; Polyquaternium 52; a copolymer of acrylic acid, acrylamide and methacrylamidopropyltrimonium chloride commercially available as Polyquaternium 53; a polymeric quaternary ammonium salt prepared by the reaction of aspartic acid and C6-C18 alkylamine with dimethylaminopropylamine and sodium chloroacetate commercially available as Polyquaternium 54; a polymeric quaternary ammonium chloride formed by the reaction of vinylpyrrolidore, dimethylaminopropyl methacrylamide and methacryloylaminopropyl lauryldimonium chloride commercially available as Polyquaternium 55; and a polymeric quaternary ammonium salt consisting of isophorone diisocyanate, butylene glycol and dihydroxyethyldimonium methosulfate monomers commercially available as Polyquaternium 56. Each of the foregoing are described in the literature, particularly in the International Cosmetic Ingredient Dictionary and Handbook, Volume 2 (9^{th} Edition, 2002), at pages 1311-1319. Other polyquaternium compounds although not specifically elucidated here may also be utilized in the present inventive compositions.

When present in the germicidal topical compositions, one or more Polyquaternium-type compounds or materials are advantageously present in amounts of from about from 0.001-5% wt., preferably in amounts from 0.01-2% wt., but are most desirably present in reduced weight percentages from about 0.05-1% wt. based on the total weight of the germicidal topical composition of which they form a part.

The germicidal topical compositions may include a cosmetic particulate, which may be any particulate material which is a solid at room temperature (approx. 20° C.) temperature and atmospheric pressure, which does not deleteriously react chemically with balance of the constituents of the inventive composition. Advantageously the cosmetic particulate is insoluble in balance of the constituents of the germicidal topical compositions, particularly when the compositions are brought to a temperature above room temperature and especially to a temperature of at least 50° C. and preferably at least 60° C. for at least 24 hours, preferably for at least 48 hours. Desirably the cosmetic particulate constituent exhibits a melting temperatures of at least 70° C., preferably at least 100° C., more preferably at least 120° C., and most preferably at least 130° C. The cosmetic particulate composition may be absorbent or non-absorbent with respect to one or more of the remaining constituents of the inventive comp ositions of which they form a part. It is to be understood that such optional “cosmetic particulate” are distinguished from the “lipid-based nanoparticles” which are essential constituents of the present invention. Advantageously the cosmetic particulate constituent may be mineral or organic, lamellar, spherical, viz., beads, or oblong. They may have a generally regular geometry, such as in the case of spheres or rods, or they may have an irregular geometry such as crushed particulate materials. Exemplary materials useful for the cosmetic particulate constituent include: inorganic particulate particles formed from talc, mica, silica, kaolin, boron nitride, carbonates such as precipitated calcium carbonate, magnesium carbonate and magnesium hydrocarbonate, hydroxyapatite, hollow silica microspheres, glass microcapsules, and ceramic microcapsules, inorganic pigments and mixtures thereof. Exemplary materials useful for the cosmetic particulate constituent include: organic particulate particles formed from polyamide powders, such as polyamides (Nylons), polyethylenes, polypropylenes, polyesters, acrylic polymers such as polymethyl methacrylate, polytetrafluoroethylene (Teflons.), as well as crystalline and microcrystalline waxes derived from plants, mineral oils or petroleum, hollow polymer microspheres such as those formed from polyvinylidene chloride/acrylonitrile, starches, alginates, organic dyestuffs or pigments, and mixtures thereof. Mixtures of two or more cosmetic particles may be used to provide the cosmetic particulate constituent. Preferred as the cosmetic particulate constituent are materials which provide an exfoliating benefit.

Preferably, these cosmetic particulates have an apparent diameter in the range of from about 100 to about 1000 μm, preferably from about 100 to about 600 μm and most preferably from about from about 250 to about 600 μm. An apparent diameter corresponds to the diameter of the circle in which the elementary particle is inscribed along its smallest dimension (thickness for lamellae).

A preferred class of cosmetic particulate materials are based on synthetically occurring or synthetic waxes inclusive of microcrystalline waxes. Exemplary useful waxes include any of those which are generally useful used in cosmetics and dermatology. Exemplary waxes of natural origin, include for instance beeswax, carnauba wax, candelilla wax, ouricoury wax, Japan wax, cork fibre wax or sugar cane wax, paraffin wax, lignite wax, microcrystalline waxes, lanolin wax, montan wax, ozokerites, hydrogenated oils, for instance hydrogenated jojoba oil. Exemplary waxes of synthetic origin include for instance polyethylene waxes derived from the polymerization of ethylene, waxes obtained by Fischer-Tropsch synthesis, esters of fatty acids and of glycer ides that are solid at 50° C. preferably at 60° C. or higher temperatures, and silicone waxes, for instance alkyl, alkoxy, and/or esters of poly(di)methylsiloxane that are solid at 50° C. preferably at 60° C. or higher temperatures. These waxes may be formed particulates, e.g., beads or spheres according to conventional methods.

Such cosmetic particulates may be provided in any effective amount, but desirably is present in amount which are aethetically pleasing to the user of the composition. The cosmetic particulate constituent is made of individual cosmetic particulate materials which may be of a uniform chemical or physical composition, and/or of a uniform size or dimension and/or of a uniform color but this is not a necessity and mixtures or different individual cosmetic particulate materials which may be differentiated on the basis of chemical and/or physical composition, and/or size or dimension and/or color may be provided as the cosmetic particulate constituent of the invention. If included in the compositions of the invention, the cosmetic particulate constituent of the invention may be provided in any effective amount, advantageously from at least 0.01% wt., preferably at least 0.05% wt, and most preferably at least 0.1% wt of the germicidal topical composition. Similarly advantageously the cosmetic particulate constituent is present in not more than 10% wt., preferably not more than 5% wt, and yet more preferably not more than 2% wt, and most preferably not more than 2% wt of the germicidal topical composition of which it forms a part.

The topical germicidal compositions may include one or more powders or pulvurent materials. These powders include mica, chalk, talc, Fullers earth, kaolin, starch, silica, silicates, hydrated aluminum silicate, fumed silica, aluminum starch octenyl succinate as well as comminuted or particulate polymers such as particles of polyamides (Nylons), polyalkyleneterephtalates (PET, PBT), polyolefins (PE) or fluoropolymers (polytetrafluoroethylene) as well as mixtures of two or more thereof. The inclusion of one or more powders in the inventive compositions may provide an improved tactile benefit and/or may act to absorb a part of one or more of the hydrophobic constituents present in the composition and/or may provide an opacifying effect to the compositions. Preferred powders are those based on inorganic materials, e.g., silica, silicates and talc. Such are typically provided to the topical germicidal compositions as finely divided particles. While such powders may be included in any effective amount, when present they are advantageously included in amounts of between about 0.01% wt. to about 5% wt., preferably between about 0.25% wt. to about 2% wt., based on the total weight of the topical germicidal composition of which they form a part.

The compositions of the invention may optionally include one or more polysiloxanes which are commonly used and often interchangeably referred to as silicone emulsifiers. Such silicone emulsifiers include polydiorganosiloxanepolyoxyalkylene copolymers containing at least one polydiorganosiloxane segment and at least one polyoxyalkylene segment. The polyoxyalkylene segments may be bonded to the polydiorganosiloxane segments with silicon-oxygen-carbon bonds and/or with silicon-carbon bonds. The polydiorganosiloxane segments of consist essentially of siloxane units which are interlinked by Si—O—Si linkages and which have the formula:

R_{b}SiO_{(4{b})/2}

The value of b may range from 0 to 3 for said siloxane units with the provision that there is an average of approximately 2, i.e. from 1.9 to 2.1 R radicals for every silicon in the copolymer. Suitable siloxane units thus include R₃SiO_{1/2}, R₂SiO_{2/2}, RSiO_{3/2}, and SiO_{4/2} siloxane units taken in such molar amounts so that b has an average value of approximately 2 in the copolymer. Said siloxane units may be arranged in linear, cyclic and/or branched fashion. The R radicals may be any radical selected from the group consisting of methyl, ethyl, vinyl, phenyl, and a divalent radical bonding a polyoxyalkylene segment to the polydiorganosiloxane segment. At least 95 percent of all R radicals are methyl radicals; preferably there is at least one methyl radical bonded to each silicon atom in (d). Divalent R radicals preferably contain no more than 6 carbon atoms. Examples of divalent R radicals include —O—, —CₘH₂ₘO—, —CₘH₂ₘ— and —CₘH₂ₘCO₂— where m is an integer greater than zero. Illustrative of the siloxane units that make up the polydiorganosiloxane segments are the following, where Me denotes methyl and Q denotes said divalent R radical and bonded polyoxyalkylene segment: R₃SiO_{1/2} units such as Me₃SiO_{1/2}, Me₂(CH₂═CH)SiO_{1/2}, Me₂(C₆H₅)SiO_{1/2}, Me(C₆H₅)(CH₂═CH)SiO_{1/2}, Me₂(CH₃CH₂)SiO_{1/2}, Me₂QSiO_{1/2}, MeQ₂SiO_{1/2}, Q₃SiO_{1/2}, Q₂(CH₃CH₂)SiO_{1/2}, and Me(C₆H₅)(Q)SiO_{1/2}; R₂SO_{2/2} units such as Me₂SiO_{2/2}, Me(C₆H₅)SiO_{2/2}, Me(CH₂═CH)SiO_{2/2}, (C₆H₅)₂SiO_{2/2}, MeQSiO_{2/2}, and Q(C₆H₅)SiO_{2/2}; RSiO_{3/2} units such as MeSiO_{3/2}, C₆H₅SO_{3/2}, CH₂═CHSiO_{3/2}, CH₃CH₂SiO_{3/2} and QSiO_{3/2}; and SiO_{4/2} units.

Volatile linear silicones including polydimethylsiloxane and dimethicones may also be present as silicone emulsifiers in compositions according to the invention.

Also useful as silicone emulsifiers in the inventive compositions are one or more compounds which may be represented by the structure:

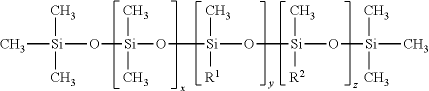

wherein

R¹ represents a C₁-C₃₀ straight chained, branched or cyclic alkyl group,

R² represents a moiety selected from:

—(CH₂)ₙO—(CH₂CHR³O)ₘ—H

and

—(CH₂)—O—(CH₂CHR³O)ₘ—(CH₂CHR⁴O)ₚ—H

in which n represents an integer from about 3 to about 10, R3 and R4 are selected from hydrogen and C1-C6 straight chain, or branched chain alkyl groups with the proviso that R³ and R⁴ are not simultaneously the same, each of m, p, x and y are independently selected from integers of zero or greater, such that the molecule has a molecular weight of between about 200 to about 20,000,000 and wherein both m and p are not both simultaneously zero, and z is selected from integers of 1 or greater.

If included in the compositions of the invention, the silicone emulsifiers may be provided in any effective amount, advantageously from at least 0.01% wt., preferably at least 0.05% wt, of the composition. Advantageously the silicone emulsifiers, when present, are present in amounts of not more than 5% wt, and yet more preferably not more than 2% wt, and most preferably not more than 2% wt of the composition of which it forms a part.

While such are expected to be unnecessary in view of the high alcohol content of the compositions, the topical germicidal compositions may include one or more preservatives. Exemplary useful preservatives include compositions which comprise parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof. Further suitable preservatives include those marketed as: KATHON CG/ICP, KATHON CG/ICP II (ex. Rohm and Haas Inc.), PROXEL (ex. Zeneca), SUTTOCIDE A (ex. Sutton Laboratories) and TEXTAMER 38AD (ex. Calgon Corp.) When present the preservative is included in any amount found to be effective in retarding or inhibiting the grown of undesired microorganisms in the topical germicidal compositions, particularly during storage for several months at room temperature. The preservative composition is advantageously present in amounts of up to about 1.5% wt., preferably from about 0.00001% wt. to about 0.5% wt., most from about 0.0001% wt. to 0.25% wt. based on the total weight of the topical composition of which it forms a part. Usually however, in light of the high alcohol content such preservatives are not required and are advantageously omitted.

The topical germicidal compositions may include one or more high molecular weight polyethylene glycol polymers (also referred to as poly(ethylene oxide) or polyoxyethylene), (“PEG”) having a molecular weight of at least about 100 preferably at least about 200, yet more preferably at least about 300, with yet higher molecular weights of about 1000 and even more also contemplated as being useful. Such are typically provided in a solid, or pulvurent form and depending upon the molecular weight may be at least partially soluble in the inventive compositions. Such materials are widely commercially available under various tradenames, inter alia, Polyox® materials (ex. Dow Chem. Co.). While such high molecular weight polyethylene glycol polymers may be included in any effective amount, when present they are advantageously included in amounts of between about 0.01% wt. to about 5% wt., preferably between about 0.25% wt. to about 4% wt., based on the total weight of the topical germicidal composition of which they form a part.

The topical germicidal compositions may include a fragrance constituent, which may be based on natural and synthetic fragrances and most commonly are mixtures or blends of a plurality of such fragrances, optionally in conjunction with a carrier such as an organic solvent or a mixture of organic solvents in which the fragrances are dissolved, suspended or dispersed. When present in a composition, the fragrance constituent may be present in any effective amount such that it can be discerned by a consumer of the topical germicidal composition, however is advantageously present in amounts of up to about 5% wt., preferably from about 0.00001% wt. to about 1.5% wt., most preferably from about 0.0001% wt. to 0.25% wt. based on the total weight of the topical composition of which it forms a part.

The inventive topical germicidal compositions may include on or more colorants, e.g, dyes or pigments which are known to the art be useful in cosmetic or topical compositions which may be used to impart a desired color or tint to the inventive compositions. Exemplary colorants include pigments, inter alia, inorganic red pigments, such as iron oxide, iron hydroxide and iron titanate; inorganic brown pigments, such as gamma-iron oxide; inorganic yellow pigments, such as iron oxide yellow and loess; inorganic black pigments, such as iron oxide black and carbon black; inorganic violet pigments, such as manganese violet and cobalt violet; inorganic green pigments, such as chromium hydroxide, chromium oxide, cobalt oxide and cobalt titanate; inorganic blue pigments, such as Prussian blue and ultramarine blue; lakes of tar pigments; lakes of natural dyes; and synthetic resin powder complexes of the inorganic pigments as recited above. Advantageously one or more colorants may be added in amounts of about 0.001% wt. to about 0.1% by weight, based on the total weight of the composition of which the colorant(s) forms a part.

The topical germicidal compositions of the invention may one or more essential oils which are selected to provide a so-called “aromatherapy benefit” or “holistic benefit” to the user. Essential oils are complex mixtures of different organic molecules, such as terpenes, alcohols, esters, aldehydes, ketones and phenols. Such essential oils are frequently extracted from naturally occurring botanical sources such as flowers, stems, leaves, roots and barks of aromatic plants. While essential oils may be used singly, it is also common to utilize blends of essential oils in order to provide a conjunctive aroma benefit, aromatherapy benefit, holistic benefit and possibly a therapeutic benefit as well.

Preferred essential oils providing an aromatherapy benefit for use in the topical germicidal compositions of the present invention include one or more selected from chamomile oil, lavendin oil, lavender oil, grapefruit oil, lemon oil, line oil, mandarin orange oil, orange flower oil and orange oil. Chamomile oil may be used to promote both a fresh, clean and attractive scent and possibly provide a stress-relaxing benefit to the user of the topical composition. Lavender oil, and lavendin, may be used to promote both a fresh and attractive scent and possibly also provide a stress-relaxing benefit to the user of the topical composition. One or more of grapefruit oil, lemon oil, line oil, mandarin orange oil, orange flower oil and orange oil provide a clean citrus scent and may possibly impart a perceived therapeutic benefit as well when used.

As used in the present invention, these one or more essential oils providing an aromatherapy benefit or holistic benefit are present in an amount about 0.00001 wt. % to about 1 wt. %, preferably from about 0.00005 wt. % to about 0.75 wt. %, and more preferably from about 0.0001 wt. % to about 0.5 wt. % of the total weight of the composition. It is to be understood that these one or more essential oils providing an aromatherapy benefit may be used with our without the optional fragrancing constituent recited previously and may be used wholly or partially in place of said fragrancing constituent.

The topical germicidal compositions may include one or more antioxidant constituents; certain of these antioxidant constituents may additionally provide an anti-wrinkling benefit to the skin or other topical treatment benefit. Examples of antioxidants include but are not limited to, water-soluble antioxidants such as sulfhydryl compounds and their derivatives (e.g., sodium metabisulfite and N-acetyl-cysteine), lipoic acid and dihydrolipoic acid, resveratrol, lactoferrin, glutathione, and ascorbic acid and ascorbic acid derivatives (e.g., ascorbyl palmitate and ascorbyl polypeptide), as well as oil-soluble antioxidants such as butylated hydroxytoluene, retinoids, tocopherols e.g., tocopherol acetate, tocotrienols, and ubiquinone, natural extracts containing antioxidants such as extracts containing flavonoids and isoflavonoids and their derivatives, extracts containing resveratrol and the like, as well as certain natural extracts e.g., grape seed, green tea, pine bark, propolis, and the like. When present the total amount of such antioxidants are usually not in excess of 5% wt, preferably from 0.0001-4% wt. based on the total weight of the topical germicidal compositions of which it forms a part. In certain preferred embodiments one or more antioxidants constituents are necessarily present.

Optionally the topical germicidal compositions may include one or more vitamins. Examples of vitamins which can be added include vitamin A, such as vitamin A oil, retinol, retinyl acetate and retinyl palmitate; vitamin B, including vitamin B₂ such as riboflavin, riboflavin butyrate and flavin adenine nucleotide, vitamin B₆ such as pyridoxine hydrochloride, pyridoxine dioctanoate and pyridoxine tripalmitate, vitamin B₁₂ and its derivatives, and vitamin B₁₅ and its derivatives; vitamin C, such as L-ascorbic acid, L-ascorbic acid dipalmitic ester, sodium (L-ascorbic acid)-2-sulfate and dipotassium L-ascorbic acid diphosphate; vitamin D, such as ergocalciferol and cholecarciferol; vitamin E, such as alpha-tocopherol, beta-tocopherol, gamma-tocopherol, dl-alpha-tocopheryl acetate, dl-alpha-tocopheryl nicotinate and dl-alpha-tocopheryl succinate. When present, in accordance with certain of the preferred embodiments, one or more vitamins may be included in effective amounts, advantageously from 0.0001-1% wt., preferably from 0.001-0.75% wt. based on the total weight of the topical germicidal compositions of which it forms a part.

The topical germicidal compositions may include one or more light stabilizers as well as UV absorbers or sunscreen constituents. Such materials are known to be useful in cosmetic or topical compositions and impart a degree of stability to the compositions which may comprise one or more components which may be deleteriously affected when exposed to certain sources of light, e.g., sunlight, fluorescent light sources. Other such materials are known to stabilize or improve the effect of colorants which may be present in the compositions. Any cosmetically acceptable material or compound which provides protection for one or more of the constituents in the inventive compositions from photolytic degradation or photo-oxidative degradation may be used. Examples include: triazines including s-triazine, triazine derivatives e.g. 2,4,6-trianilino-(p-carbo-2′-ethyl-1′-hexyloxy)-1,3,5-triazine, anisotriazine, ethylhexyltriazone, diethylhexylbutamidotriazone; benzotriazoles and derivatives; esters of benzalmalonic acid; sulphonic acid derivatives of 3-benzylidencamphen; cinnamic acid and cinnamic acid amides, esters of cinnamonic acid; propane-1,3-diones; phenylbenzimidazoles and sulfonated benzimidazoles; salicylic acid derivatives including esters of salicylic acid, e.g., ethylhexyl salicylate, dipropylene glycol salicylate, TEA salicylate, salicylic acid 2-ethylhexylester, salicylic acid 4-isopropyl benzylester, salicylic acid homomethylester; compounds or derivatives of compounds based on benzylidenecamphor, and the like. Any of the foregoing materials provided as acids may used in free acid form or as a salt thereof, e.g., an alkali, alkaline earth, ammonium, alkylammonium, alkanolammonium salt form thereof. When present, the one or more light stabilizers as well as UV absorbers may be included in any effective amount; advantageously such materials are present in amounts of from 0.0001-1% wt., preferably from 0.001-0.5% wt. based on the total weight of the topical germicidal composition of which it forms a part.

The inventive topical germicidal compositions may comprise further one or more further antimicrobial agents. Such further antimicrobial agent is/are one or more compounds which provide an appreciable germicidal benefit. Such further antimicrobial agent desirably provides an effective antimicrobial benefit to treated dermal surfaces, e.g., hands, arms, etc. The further antimicrobial agent may be include one or more cationic surfactant constituents, especially preferably one or more cationic surfactants which provide an appreciable germicidal benefit. Non-limiting examples of preferred cationic surfactant compositions which may be included in the treatment compositions are those which provide an appreciable germicidal benefit, and especially preferred are quaternary ammonium compounds and salts thereof, which may be characterized by the general structural formula:

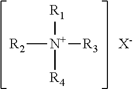

where at least one of R₁, R₂, R₃ and R₄ is a alkyl, aryl or alkylaryl substituent of from 6 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the abovementioned alkyl substituents are hydrocarbons usually containing no more than 12 carbon atoms. The substituents R₁, R₂, R₃ and R₄ may be straight-chained or may be branched, but are preferably straight-chained, and may include one or more amide, ether or ester linkages. The counterion X may be any salt-forming anion which permits water solubility or water miscibility of the quaternary ammonium complex. Preferred quaternary ammonium compounds which act as germicides according to the foregoing formula are those in which R₂ and R₃ are the same or different C₈-C₁₂alkyl, or R₂ is C₁₂₋₁₆alkyl, C₈₋₁₈alkylethoxy, C₈₋₁₈alkylphenolethoxy and R₃ is benzyl, and X is a halide, for example chloride, bromide or iodide, or is a methosulfate anion. The alkyl groups recited in R₂ and R₃ may be straight-chained or branched, but are preferably substantially linear.

The further antimicrobial agent may include one or more of: pyrithiones such as zinc pyrithione, halohydantoins such as dimethyldimethylol hydantoin, methylchloroisothiazolinone/methylisothiazolinone sodium sulfite, sodium bisulfite, imidazolidinyl urea, diazolidinyl urea, benzyl alcohol, 2-bromo-2-nitropropane-1,3-diol, formalin (formaldehyde), iodopropenyl butylcarbamate, chloroacetamide, methanamine, methyldibromonitrile glutaronitrile, glutaraldehyde, 5-bromo-5-nitro-1,3-dioxane, phenethyl alcohol, o-phenylphenol/sodium o-phenylphenol, sodium hydroxymethylglycinate, polymethoxy bicyclic oxazolidine, dimethoxane, thimersal dichlorobenzyl alcohol, captan, chlorphenenesin, dichlorophene, chlorbutanol, glyceryl laurate, halogenated diphenyl ethers such as 2,4,4-trichloro-2-hydroxy-diphenyl ether (Triclosan®) and 2,2-dihydroxy-5,5-dibromo-diphenyl ether, phenolic antimicrobial compounds such as mono- and poly-alkyl and aromatic halophenols, such as p-chlorophenol, methyl p-chlorophenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol, dichloro meta xylenol, chlorothymol, and 5-chloro-2-hydroxydiphenylmethane, resorcinol and its derivatives, bisphenolic compounds such as 2,2-methylene bis(4-chlorophenol) and bis(2-hydroxy-5-chlorobenzyl)sulphide, benzoic esters (parabens), halogenated carbanilides such as 3-trifluoromethyl-4,4′-dichlorocarbanilide (Triclocarban), 3-trifluoromethyl-4,4-dichlorocarbanilide and 3,3,4-trichlorocarbanilide. The further antimicrobial agent may include one or more of: biguanides such as polyhexamethylene biguanide, p-chlorophenyl biguanide; 4-chlorobenzhydryl biguanide, 1,6-bis-(4-chlorobenzylbiguanido)-hexane (Fluorhexidine®), halogenated hexidine including, but not limited to, chlorhexidine (1,1′-hexamethylene-bis-5-(4-chlorophenyl biguanide) (Chlorohexidine®), as well as salts of any of the foregoing, e.g. polyhexamethylene biguanide hydrochloride.

Desirably, when present, such further antimicrobial agent may be included in the inventive compositions in any effective amount. Advantageously such amounts are from about 0.0001-2% wt., but preferably are from about 0.01-1% wt. of the topical germicidal composition of which they form a part.

In certain particularly preferred embodiments, the inventive compositions expressly exclude such a further antimicrobial constituent.

In order to adjust the pH of the inventive compositions, one or more pH adjusting agents as well as one or more pH buffers may optionally be included in the germicidal topical compositions in effective amounts. By way of non-limiting example pH adjusting agents include phosphorus containing compounds, monovalent and polyvalent salts such as of silicates, carbonates, and borates, certain acids and bases, tartrates and certain acetates. Further exemplary pH adjusting agents include mineral acids, basic compositions, and organic acids, which are typically required in only minor amounts. By way of further non-limiting example pH buffering compositions include the alkali metal phosphates, polyphosphates, pyrophosphates, triphosphates, tetraphosphates, silicates, metasilicates, polysilicates, carbonates, hydroxides, and mixtures of the same. Certain salts, such as the alkaline earth phosphates, carbonates, hydroxides, can also function as buffers. It may also be suitable to use as buffers such materials as aluminosilicates (zeolites), borates, aluminates and certain organic materials such as gluconates, succinates, maleates, and their alkali metal salts. When present, the pH adjusting agent, especially the pH buffers are present in an amount effective in order to maintain the pH of the inventive composition within a desired or a target pH range. Advantageously they may be included in generally minor amounts such as from 0.001-1.5% wt. but desirably are present in amounts from 0.01-1% wt. Exemplary and preferred pH buffers and pH adjusting agents are described with reference to one or more of the following Examples.

The inventive germicidal topical compositions may include one or more chelating agents. Exemplary useful chelating agents include those known to the art, including by way of non-limiting example; aminopolycarboxylic acids and salts thereof wherein the amino nitrogen has attached thereto two or more substituent groups. Preferred chelating agents include acids and salts, especially the sodium and potassium salts of ethylenediaminetetraacetic acid, diethylenetriaminepentaacetic acid, N-hydroxyethylethylenediaminetriacetic acid, and of which the sodium salts of ethylenediaminetetraacetic acid may be particularly advantageously used. Such chelating agents may be omitted, or they may be included in generally minor amounts such as from 0.001-0.5% wt. based on the weight of the chelating agents and/or salt forms thereof. Desirably, such chelating agents are included in the present inventive composition in amounts from 0.01-0.5% wt., but are most desirably present in reduced weight percentages from about 0.01-0.2% wt.

The compositions exhibit a pH in the range of from about 4 to about 7.5, preferably a pH in the range of from about 4 to about 6.5. Particularly preferred pH ranges are disclosed with reference to one or more of the examples. When necessary a pH adjusting agent or constituent may be used; examples of which are discussed elsewhere in this specification.

Surprisingly the compositions of the invention were observed to exhibit good technical performance characteristics in several respects. The compositions provided excellent pH and viscosity stability, skin feel and lotion-like appearance.

The topical germicidal compositions are preferably flowable, and depending upon the product form may be provided in variety of viscosity ranges suited for a particular product type. For example, the topical germicidal compositions may be provided as thin “cosmetic milk” product format, and may have a viscosity as little at about 500 cP typically to about 2500 cP, while in a “lotion” product format may have somewhat higher viscosities as well, typically in the range of from about 2000 cP to about 30,000 cP, preferably in the range of about 2000 to about 15,000 cP, while in a more viscous format such as a gel or thickened lotion may have a viscosity of about 9,000 cP or more, such as between about 10,000 cP and about 20,000 cP. Still more viscous forms of the topical germicidal compositions may be formed and are contemplated to be within the scope of the present invention, e.g., in the range of 10-100,000 cP at 25° C. as measured using conventional quantitative methods e.g., as measured at 20° C. or 25° C. by a Brookfield Type LVT or Type RVT viscometer using a standard spindle, (e.g., a #6 spindle), and measuring the samples at room temperature (20-22° C.). The aforesaid viscosities are ones which may be based on the “as mixed” topical germicidal compositions but preferably are evaluated after at least 1 week, preferably at least 2 weeks of storage of a sample of the topical germicidal composition maintained at a temperature of at least 30° C. preferably at least 40° C. Certain preferred viscosities and storage time and temperature conditions are disclosed with reference to one or more of the examples.

In a further aspect, the present invention also comprises a method for providing a treatment benefit and/or providing an germicidal benefit to skin or other topical surface which method includes the topical application of the topical germicidal compositions as described herein in a treatment and/or germicidally effective amount. Preferably according to the foregoing method, a germicidal benefit is provided to the skin or other topical surface to which the composition has been applied. Preferred embodiments of the topical germicidal compositions exhibit good germicidal efficacy of undesired microorganisms, e.g, S. aureus, E. coli, P. auruginosa, as well as E. hirae on dermal (viz., skin. body) surfaces. Advantageously the topical germicidal compositions exhibit antimicrobial efficacy against one or more of certain gram positive pathogens, certain gram negative pathogens, certain viruses, certain fungi and/or certain mold. In certain preferred embodiments the topical germicidal compositions are effective against one or more, preferably at least two or more of the following microorganisms: B. cepacia, E. coli, S. aureus, S. marcenscens, S. pyogenes, S. epidermidis, E. faecalis, K pneumoniae, P. aeruginosa, E. hirae, S. pneumoniae, C. albicans, S. enterica, and methicillin resistant Staphylococcus aureus (“MRSA”).

While the topical germicidal compositions disclosed herein find a primary use in application to the skin to provide a treatment benefit and/or germicidal benefit thereto and is contemplated as being provided in a dispenser for use in such a treatment, it is to be understood that this is not to be understood as a limiting definition and that other forms and other uses of the present inventive composition, such as face lotion, milky lotion, cream, face cleansing cream, massage materials, liquid toilet soap, as well as in hair care products such as shampoo, rinse or other hair or scalp treatment are expressly contemplated as being within the scope of the present invention. The topical germicidal compositions of the invention are beneficially formulated as a pourable lotion, a cosmetic milk, a liquid or a spray, but may also be formulated as a more viscous a cream or a gel, which may be transparent, translucent or opaque. In certain preferred embodiments the topical germicidal compositions is provided as a translucent composition.

The composition can be packaged in a suitable container to suit its viscosity and intended use by the consumer. For example, a lotion or cream can be packaged in a bottle, or can be packaged with a propellant in a propellant-driven aerosol device or alternately may be packaged in a container fitted with a manually operable pump. When the compositions of the invention have higher viscosities and is in the form of a paste, gel or cream it may conveniently be provided in a resealable container with a relatively wide opening, e.g., a jar, tin, tub or bottle with a removable and replaceable cap or cover. Forms of the composition which have low viscosities may be provided in bottles or flasks from which they be dispensed by pouring, or by pumping such as via a manually pumpable trigger pump or manually operable trigger spray pump. The inventive composition can be provided and stored in a non-deformable bottle but more preferably is provided in a squeezable container, such as a tube or deformable bottle which provides for easy dispensing of the composition by the consumer. Thus a further aspect of the invention provides a closed container containing the inventive composition as described herein.

It is to be further expressly understood that topical application of the topical germicidal compositions disclosed herein may be applied to the skin on any part of the body, including the skin on the face, neck, chest, back, arms, axilla, hands, legs, and scalp. The topical germicidal compositions disclosed herein may also be used on the hair. Preferably the topical germicidal compositions are not ingested or used on mucous tissues.

It is contemplated that in use, the consumer dispenses a quantity of the topical germicidal composition described herein and applied it to the skin or any other part of the body where they may be retained upon but are beneficially rubbed into the applied skin or other part of the body by the consumer to provide both a skin moisturization benefit concurrently with a germicidal benefit to the treated skin or other part of the body. Advantageously the thus applied topical germicidal composition is allowed to remain on the skin or other part of the body to which it has been applied, without any subsequent washing or rinsing. However, if desired by a consumer, the topical germicidal treatment compositions may be rinsed by the consumer under a stream of running water, e.g, in a shower or by immersion into water, e.g, a bath. Thus, a further aspect of the invention is directed to the use of the topical germicidal compositions as described herein.

The following examples below illustrate exemplary formulations as well as preferred embodiments of the invention. It is to be understood that these examples are provided by way of illustration only and that further useful formulations falling within the scope of the present invention and the claims may be readily produced by one skilled in the art without deviating from the scope and spirit of the invention.

### EXAMPLES

A number of topical germicidal compositions were produced and are described on Tables 1A—below. In the following compositions, the constituents were used “as supplied” from their respective suppliers and may constitute less than 100% wt. “actives”, or may have been supplied as constituting 100% wt. “active” of the named compound, as indicated in the following Tables 1A- and 2. In each of the topical germicidal compositions, deionized water was added in “quantum sufficient” “q.s.” in order to provide to 100% wt. of each composition. The compositions disclosed on Table 1 demonstrate compositions according to the invention, including certain preferred embodiments of the invention.

TABLE 1A

| | E1 | E2 | E3 |
|---|---|---|---|
| denatured ethanol | 66 | 66 | 66 |
| acrylic acid polymer (1) | 0.3 | 0.3 | 0.3 |
| tetrahydroxypropyl ethylenediamine | 0.3 | 0.3 | 0.3 |
| propylene glycol | 0.5 | 0.5 | 0.5 |
| propalkylene glycol | 1 | 1 | 1 |
| lipid nanoparticles (1) | 5 | — | — |
| lipid nanoparticles (2) | — | 5 | — |
| lipid nanoparticles (3) | — | — | 5 |
| fragrance | 0.025 | 0.025 | 0.025 |
| d.i. water | q.s. | q.s. | q.s. |
| viscosity (cP) | 27000 | 5750 | 8000 |

TABLE 1B

| | E4 | E5 | E6 |
|---|---|---|---|
| denatured ethanol | 66 | 66 | 66 |
| acrylic acid polymer (1) | 0.3 | 0.3 | 0.3 |
| tetrahydroxypropyl ethylenediamine | 0.3 | 0.3 | 0.3 |
| propylene glycol | 0.5 | 0.5 | 0.5 |
| propalkylene glycol | 1 | 1 | 1 |
| lipid nanoparticles (1) | 1 | — | — |
| lipid nanoparticles (2) | — | 1 | — |
| lipid nanoparticles (3) | — | — | 1 |
| fragrance | 0.025 | 0.025 | 0.025 |
| d.i. water | q.s. | q.s. | q.s. |
| viscosity (cP) | 27000 | 5750 | 8000 |

TABLE 1C

| | E7 |
|---|---|
| denatured ethanol | 66 |
| acrylic acid polymer (1) | 0.25 |
| acrylic acid polymer (2) | 0.025 |
| tetrahydroxypropyl ethylenediamine | 0.28 |
| propylene glycol | 0.5 |
| lipid nanoparticles (1) | 1 |
| fragrance | 0.025 |
| d.i. water | q.s. |
| viscosity (cP) | 7500 |

The identity of the individual constituents used in the compositions are described more fully on Table 2.

TABLE 2

| | |
|---|---|
| d.i. water | deionized water |
| denatured ethanol | germicide/antimicrobial; denatured |
| | ethanol, 96% wt. actives, also included a |
| | minor amount of BITREX |
| glycerine | glycerine, USP grade (99.5% wt. actives) |
| acrylic acid polymer (1) | rheology modifier; supplied as Carbopol |
| | Ultrez 20, 100% wt. actives (ex. Lubrizol) |
| acrylic acid polymer (2) | rheology modifier; supplied as Pemulin |
| | TR-1, 100% wt. actives (ex. Lubrizol) |
| tetrahydroxypropyl | chelant/neutralizing agent; supplied as |
| ethylenediamine | Neutrol TE, 100% wt actives (ex. BASF) |
| propylene glycol | humectant, |
| propalkylene glycol | water soluble emollient; supplied as UCON |
| | 75-H-450; 100% wt. actives (ex. Dow) |
| lipid nanoparticles (1) | Lipid nanoparticles, comprising 4% |
| | Ceramide II, 4% cholesterol, and |
| | phospholipids; supplied as NanoSolve ™ |
| | 4101, used “as supplied” (ex. Lipod GmbH, |
| | Ludwigshafen, Germany) |
| lipid nanoparticles (2) | Lipid nanoparticles, comprising 10% |
| | Coenzyme Q10; supplied as NanoSolve ™ |
| | 4022, used “as supplied” (ex. Lipod GmbH, |
| | Ludwigshafen, Germany) |
| lipid nanoparticles (3) | Lipid nanoparticles, comprising 5% Vitamin |
| | A palmitate; supplied as NanoSolve ™ |
| | 8034, used “as supplied” (ex. Lipod GmbH, |
| | Ludwigshafen, Germany) |
| fragrance | proprietary composition of its supplier |

The compositions according to E1, E2 and E3 were produced in accordance with the following general protocol: A major amount of the d.i. water was provided to a laboratory beaker mounted on a support stand to which was affixed a motorized stirrer. The water, and all constituents were at room temperature (approx. 20° C.). The motorized stirrer was activated, and to the stirred water was slowly added the acrylic acid polymer (1) under stirring conditions until the contents of the beaker were homogenous. Subsequently was slowly added the denatured ethanol under stirring conditions until a homogenous mixture was formed. Thereafter was added the glycerin, propylene glycol, propalkylene glycol, lipid nanoparticles and fragrance one at a time, mixing well between each addition to ensure homogeneity before the addition of the next constituent. Subsequently was added the tetrahydroxypropyl ethylenediamine to neutralize the acrylic acid polymer (1). Thereafter the composition was slowly mixed for at least 15 minutes to ensure homogeneity of the example compositions.

The compositions according to E1, E2 and E3 were visually evaluated, and it was observed that all three compositions were whitish with no visible separate into separate phases, which indicated the formation of a stable emulsion. The E1, E2 and E3 compositions were evaluated as to their viscosity by using a Brookfield Viscometer, operating at 20 rpm utilizing a #6 spindle with the samples at room temperature (20-22° C.). The observed viscosities are reported on Table 1A.

The compositions according to E4, E5, E6 and E7 were produced in accordance with the following general protocol: to form a prebatch, the d.i. water at room temperature (approx. 20° C.) was supplied to a beaker mounted on a stand which included a motorized stirrer which was thereafter activated. To the stirring contents of the beaker was supplied the lipid nanoparticles, and under stirring conditions the contents of the beaker were heated to 70-75° C., and the temperature was maintained for 30 minutes. Subsequently the heat source was removed and under stirring conditions the contents of the beaker were allowed to cool under room temperature conditions to about 40° C., at which point the acrylic acid polymer (1) and acrylic acid polymer (2) were added, under stirring conditions, to the beaker. Thereafter, the ethanol was slowly added to the stirring composition, and stirring continued for at least 5 minutes to ensure that the composition was homogenous. Next was added the propylene glycol and the contents of the beaker were mixed until uniform, then sequentially the remaining constituents which were added individually and after each addition the contents of the beaker were allowed to mix until homogenous before the addition of the next constituent. The final constituent which was added was the tetrahydroxypropyl ethylenediamine to neutralize the acrylic acid polymers (1), (2), and subsequent slow mixing was maintined for at least 20 minutes after this final addition to ensure homogeneity of the example compositions.

Thereafter these compositions were subjected to storage stability testing wherein the compositions were subjected to being stored in sealed glass sample jars at temperatures of 4° C., room temperature (“RT”; 20-22° C.), 25° C., 30° C., 40° C., and 50° C., as well as being frozen and thawed and then permitted to equilibrate to room temperature. The samples were stored at the foregoing temperatures for up to 12 weeks, during which time the samples were withdrawn periodically, permitted to equilibrate to room temperature, and then evaluated both visually as to appearance and to determine if any separation of the test composition occurred, and also to evaluate the pH and the viscosity of the samples. These tests and observations are reported on the following Table 3. It is to be noted that not all of the samples were subjected to a full test protocol.

TABLE 3

| E4: initial testing | | E4: freeze/thaw testing, after 1 week storage at RT |
|---|---|---|
| storage temperature | RT | RT |
| pH | 7.68 | 7.78 |
| viscosity (cP) | 10000 | 10750 |
| appearance | hazy | hazy |
| phase separation? | no | no |

E4: 1 week

| | | | | | |
|---|---|---|---|---|---|
| storage temperature | — | — | — | — | 60° C. |
| pH | — | — | — | — | 7.76 |
| viscosity (cP) | — | — | — | — | 6500 |
| appearance | — | — | — | — | hazy |
| phase separation? | — | — | — | — | no |

E4: 2 weeks

| | | | | | |
|---|---|---|---|---|---|
| storage temperature | 4° C. | 25° C. | 30° C. | 40° C. | 50° |
| pH | 7.65 | 7.78 | 7.66 | 7.64 | 7.71 |
| viscosity (cP) | 10000 | 10000 | 11000 | 10500 | 7500 |
| appearance | milky | milky | milky | milky | milky |
| phase separation? | no | no | no | no | no |

E4: 4 weeks

| | | | | | |
|---|---|---|---|---|---|
| storage temperature | 4° C. | 25° C. | 30° C. | 40° C. | 50° |
| pH | 7.79 | 7.76 | 7.66 | 7.64 | 7.71 |
| viscosity (cP) | 9500 | 10000 | 11000 | 10500 | 7500 |
| appearance | hazy | hazy | hazy | hazy | hazy |
| phase separation? | no | no | no | no | no |

E4: 6 weeks

| | | | | | |
|---|---|---|---|---|---|
| storage temperature | 4° C. | 25° C. | 30° C. | 40° C. | 50° |
| pH | 7.47 | 7.45 | 7.42 | 7.38 | 7.34 |
| viscosity (cP) | 6000 | 6000 | 5500 | 5500 | 5000 |
| appearance | transparent | transparent | transparent | transparent | transparent |
| phase separation? | no | no | no | no | no |

E4: 8 weeks

| | | | | | |
|---|---|---|---|---|---|
| storage temperature | 4° C. | 25° C. | 30° C. | 40° C. | — |
| pH | 7.61 | 7.49 | 7.6 | 7.58 | — |
| viscosity (cP) | 12000 | 10500 | 9500 | 12500 | — |
| appearance | transparent | transparent | transparent | transparent | — |
| phase separation? | no | no | no | no | — |

E4: 12 weeks

| storage temperature | 4° C. | 25° C. | 30° C. | 40° C. | — |
|---|---|---|---|---|---|
| pH | 7.61 | 7.56 | 7.62 | 7.62 | — |
| viscosity (cP) | 9500 | 11000 | 8000 | 8500 | — |
| appearance | transparent | transparent | transparent | transparent | — |
| phase separation? | no | no | no | no | — |
| E5: initial testing | | E5: freeze/thaw testing, after 1 week storage at RT | | | |
| storage temperature | RT | RT | | | |
| pH | 7.67 | 7.78 | | | |
| viscosity (cP) | 9000 | 8250 | | | |
| appearance | milky | milky | | | |
| phase separation? | no | no | | | |

E5: 1 week

| | | | | | |
|---|---|---|---|---|---|
| storage temperature | — | — | — | — | 60° C. |
| pH | — | — | — | — | 7.74 |
| viscosity (cP) | — | — | — | — | 10000 |
| appearance | — | — | — | — | milky |
| phase separation? | — | — | — | — | no |

E5: 2 weeks

| | | | | | |
|---|---|---|---|---|---|
| storage temperature | 4° C. | 25° C. | 30° C. | 40° C. | 50° |
| pH | 7.78 | 7.74 | 7.64 | 7.7 | 7.76 |
| viscosity (cP) | 9000 | 9000 | 8500 | 8000 | 10000 |
| appearance | milky | milky | milky | milky | milky |
| phase separation? | no | no | no | no | no |

E5: 4 weeks

| | | | | | |
|---|---|---|---|---|---|
| storage temperature | 4° C. | 25° C. | 30° C. | 40° C. | 50° |
| pH | 7.73 | 7.84 | 7.77 | 7.8 | 7.76 |
| viscosity (cP) | 9000 | 8500 | 8250 | 7500 | 7000 |
| appearance | milky | milky | milky | milky | milky |
| phase separation? | no | no | no | no | no |

E5: 6 weeks

| | | | | | |
|---|---|---|---|---|---|
| storage temperature | 4° C. | 25° C. | 30° C. | 40° C. | 50° |
| pH | 7.66 | 7.7 | 7.65 | 7.71 | 7.68 |
| viscosity (cP) | 8000 | 8750 | 7500 | 7000 | 10000 |
| appearance | milky | milky | milky | milky | milky |
| phase separation? | no | no | no | no | no |

E5: 8 weeks

| | | | | | |
|---|---|---|---|---|---|
| storage temperature | 4° C. | 25° C. | 30° C. | 40° C. | — |
| pH | 7.69 | 7.6 | 7.6 | 7.59 | — |
| viscosity (cP) | 8750 | 8500 | 8500 | 7250 | — |
| appearance | milky | milky | milky | milky | — |
| phase separation? | no | no | no | no | — |

E5: 12 weeks

| storage temperature | 4° C. | 25° C. | 30° C. | 40° C. | — |
|---|---|---|---|---|---|
| pH | 7.58 | 7.56 | 7.56 | 7.63 | — |
| viscosity (cP) | 8500 | 9000 | 8000 | 7500 | — |
| appearance | milky | milky | milky | milky | — |
| phase separation? | no | no | no | no | — |
| E6: initial testing | | E6: freeze/thaw testing, after 1 week storage at RT | | | |
| storage temperature | RT | RT | | | |
| pH | 7.59 | 7.68 | | | |
| viscosity (cP) | 7000 | 7000 | | | |
| appearance | milky | milky | | | |
| phase separation? | no | no | | | |

E6: 1 week

| | | | | | |
|---|---|---|---|---|---|
| storage temperature | — | — | — | — | 60° C. |
| pH | — | — | — | — | 7.5 |
| viscosity (cP) | — | — | — | — | 6000 |
| appearance | — | — | — | — | transparent |
| phase separation? | — | — | — | — | no |

E6: 2 weeks

| | | | | | |
|---|---|---|---|---|---|
| storage temperature | 4° C. | 25° C. | 30° C. | 40° C. | 50° |
| pH | 7.61 | 7.66 | 7.59 | 7.44 | 7.47 |
| viscosity (cP) | 7500 | 7500 | 6750 | 6250 | 6000 |
| appearance | milky | milky | transparent | transparent | transparent |
| phase separation? | no | no | no | no | no |

E6: 4 weeks

| | | | | | |
|---|---|---|---|---|---|
| storage temperature | 4° C. | 25° C. | 30° C. | 40° C. | 50° |
| pH | 7.52 | 7.7 | 7.47 | 7.43 | 7.47 |
| viscosity (cP) | 7000 | 7250 | 6250 | 6250 | 7000 |
| appearance | hazy | transparent | transparent | transparent | transparent |
| phase separation? | no | no | no | no | no |

E6: 6 weeks

| | | | | | |
|---|---|---|---|---|---|
| storage temperature | 4° C. | 25° C. | 30° C. | 40° C. | 50° |
| pH | 7.7 | 7.66 | 7.53 | 7.61 | 7.65 |
| viscosity (cP) | 9500 | 10500 | 8000 | 8000 | 6000 |
| appearance | transparent | transparent | transparent | transparent | transparent |
| phase separation? | no | no | no | no | no |

E6: 8 weeks

| | | | | | |
|---|---|---|---|---|---|
| storage temperature | 4° C. | 25° C. | 30° C. | 40° C. | — |
| pH | 7.34 | 7.34 | 7.34 | 7.35 | — |
| viscosity (cP) | 6500 | 6500 | 7500 | 6000 | — |
| appearance | transparent | transparent | transparent | transparent | — |
| phase separation? | no | no | no | no | — |

E6: 12 weeks

| storage temperature | 4° C. | 25° C. | 30° C. | 40° C. | — |
|---|---|---|---|---|---|
| pH | 7.35 | 7.32 | 7.3 | 7.24 | — |
| viscosity (cP) | 7500 | 6500 | 6000 | 5000 | — |
| appearance | transparent | transparent | transparent | transparent | — |
| phase separation? | no | no | no | no | — |
| E7: initial testing | | E7: freeze/thaw testing, after 1 week storage at RT | | | |
| storage temperature | RT | RT | | | |
| pH | 7.87 | 7.81 | | | |
| viscosity (cP) | 7500 | 6750 | | | |
| phase separation? | no | no | | | |

E7: 1 week

| | | | | | |
|---|---|---|---|---|---|
| storage temperature | — | — | — | — | 60° C. |
| pH | — | — | — | — | 7.81 |
| viscosity (cP) | — | — | — | — | 6000 |
| phase separation? | — | — | — | — | no |

E7: 2 weeks

| | | | | | |
|---|---|---|---|---|---|
| storage temperature | 4° C. | 25° C. | 30° C. | 40° C. | 50° |
| pH | 7.72 | 7.74 | 7.78 | 7.81 | 7.78 |
| viscosity (cP) | 7000 | 6250 | 6000 | 6000 | 6000 |
| phase separation? | no | no | no | no | no |

E7: 4 weeks

| | | | | | |
|---|---|---|---|---|---|
| storage temperature | 4° C. | 25° C. | 30° C. | 40° C. | 50° |
| pH | 7.72 | 7.74 | 7.78 | 7.81 | 7.78 |
| viscosity (cP) | 7000 | 6250 | 6000 | 6000 | 6000 |
| phase separation? | no | no | no | no | no |

E7: 6 weeks

| | | | | | |
|---|---|---|---|---|---|
| storage temperature | 4° C. | 25° C. | 30° C. | 40° C. | 50° |
| pH | 6.99 | 7.62 | 7.72 | 7.7 | 7.69 |
| viscosity (cP) | 6750 | 6000 | 5500 | 5250 | 5500 |
| phase separation? | no | no | no | no | no |

E7: 8 weeks

| | | | | | |
|---|---|---|---|---|---|
| storage temperature | 4° C. | 25° C. | 30° C. | 40° C. | — |
| pH | 7.3 | 7.49 | 7.45 | 7.49 | — |
| viscosity (cP) | 6500 | 6500 | 5500 | 5250 | — |
| phase separation? | no | no | no | no | — |

E7: 12 weeks

| | | | | | |
|---|---|---|---|---|---|
| storage temperature | 4° C. | 25° C. | 30° C. | 40° C. | — |
| pH | 7.43 | 7.77 | 7.61 | 7.27 | — |
| viscosity (cP) | 6000 | 6000 | 5500 | 5250 | — |
| phase separation? | no | no | no | no | — |

“—“ indicates not tested at indicated conditions

As is visible from the foregoing reported results the compositions of E4, E5 and E6 were relatively insensitive to different storage times and temperatures as evidenced by a retention of similar pH and similar viscosities to the initial “as mixed” compositions initially reported on Table 3 for each of E4, E5 and E6. More notably, and more surprisingly, the compositions of E7 exhibited even more consistent pH and viscosity values over time and temperature conditions of the storage testing to which the sample compositions of E7 were subjected.

While the invention is susceptible of various modifications and alternative forms, it is to be understood that specific embodiments thereof have been shown by way of example in the drawings which are not intended to limit the invention to the particular forms disclosed; on the contrary the intention is to cover all modifications, equivalents and alternatives falling within the scope and spirit of the invention as expressed in the appended claims.

1. Topical germicidal composition comprising:
at least 50% wt. of one or more C₁-C₄ monohydric alcohols,
0.01-10% wt. of lipid-based nanoparticles,
a thickener constituent, and
water in an amount not in excess of 45% wt.

2. The topical germicidal composition according to claim 1, wherein the thickener constituent is based on crosslinked polycarboxylate polymer thickeners.

3. The topical germicidal composition according to claim 2, wherein the thickener constituent is a polyacrylate polymer thickener.

4. The topical germicidal composition according to claim 1, wherein the lipid-based nanoparticles are solid lipid nanoparticles.

5. The topical germicidal composition according to claim 4, wherein the nanoparticles have a size in the range of from about 10 to about 1000 nm.

6. The topical germicidal composition according to claim 4, wherein the nanoparticles are carriers for further constituents which provide a skin treatment benefit thereto.

7. The topical germicidal composition according to claim 6, wherein one or more further constituents are selected from the group consisting of: ceramides, cholesterol, phospholipids, Coenzyme Q10, phytosterols, lutein, Vitamin E acetate, Vitamin A palmitate, curcumin and retinyl palmitate.

8. A method for the manufacture of a topical germicidal composition according to claim 1 comprising:
forming a prebatch of an aqueous mixture of the water and the lipid-based nanoparticles at room temperature;
heating the mixture to a temperature of at least 70-75° C.;
cooling the prebatch to about 40° C.; and
adding the remaining constituents of the topical germicidal composition under stirring conditions to form a homogenously mixed topical germicidal composition.

9. A method of topical surface application comprising:
providing the topical germicidal composition of claim 1; and
applying a treatment effective amount of the topical germicidal composition to the topical surface.

10. The method according to claim 9, wherein the treatment effective amount of the topical germicidal composition provides germicidal efficacy against one or more undesired microorganisms selected from the group consisting of: S. aureus, E. coli, P. auruginosa, and E. hirae on dermal surfaces.

11. The topical germicidal composition according to claim 1, wherein at least one of the one or more C₁-C₄ monohydric alcohols comprises ethanol.

12. The topical germicidal composition according to claim 1, wherein the nanoparticles are carriers for one or more of nutritional, occlusive, emollient, and antibacterial constituents.

13. The topical germicidal composition according to claim 1, wherein at least one of the one or more C₁-C₄ monohydric alcohols comprises ethanol;
wherein the thickener constituent is a polyacrylate polymer thickener; and
wherein the nanoparticles have a size in the range of from about 10 to about 1000 nm.

14. The method according to claim 8, wherein the topical germicidal composition comprises the topical germicidal composition of claim 13.

15. The method according to claim 9, wherein the topical germicidal composition comprises the topical germicidal composition of claim 13.

16. The method according to claim 10, wherein the topical germicidal composition comprises the topical germicidal composition of claim 13.
